(19) United States
(12) Patent Application Publication
(10) Pub. No.: US 2013/0019840 A1
(43) Pub. Date: Jan. 24, 2013

(54) Engine and Engine Working Machine

(71) Applicants: Hirohide Kawada, Ibaraki (JP); Shigetoshi Ishida, Ibaraki (JP)

(72) Inventors: Hirohide Kawada, Ibaraki (JP); Shigetoshi Ishida, Ibaraki (JP)

(73) Assignee: HITACHI KOKI CO., LTD., Tokyo (JP)

(21) Appl. No.: 13/553,981

(22) Filed: Jul. 20, 2012

(30) Foreign Application Priority Data
Jul. 21, 2011 (JP) 2011-159806

(51) Int. Cl. F01L 9/04; F02D 9/02

(52) U.S. Cl. 123/348; 123/90.11

(57) ABSTRACT

An engine includes: a cylinder block with a piston being able to reciprocate therein; a carburetor configured to supply an air-fuel mixture into the cylinder block; a crankcase formed with a crank chamber; a reed valve made of a magnetic material and provided in an air-fuel mixture passage through which the air-fuel mixture passes; an electromagnet including an iron core having at least two magnetic pole pieces facing the reed valve, and a coil wound around a portion of the iron core; and a control unit configured to control the electromagnet.

### CROSS-REFERENCE TO RELATED APPLICATION

This application is based upon and claims the benefit of priority of Japanese Patent Application No. 2011-159806 filed on Jul. 21, 2011, the contents of which are incorporated herein by reference in its entirety.

### BACKGROUND

The invention relates to an engine including a reed valve for use in a brush cutter, a chain saw, or the like, and more particularly, to an engine and an engine working machine which can forcibly cut off a reed valve by the means of electrical control.

In small working machines such as a brush cutter or a chain saw, a small engine, in particular, a two-cycle engine, is widely used as a power source as disclosed in JP-H07-253033A. FIG. 22 is a perspective view illustrating a brush cutter 1001 which is one example of an engine working machine. As illustrated in FIG. 22, the brush cutter 1001 includes a small two-cycle engine suitable to be mounted on a portable engine working machine, an engine cover 1002 for accommodating the engine therein, and a rotating blade 1003 attached to a front end portion of a manipulation rod 1005. The engine and the engine cover 1002 covering the engine are attached to a rear end portion of the manipulation rod 1005. The output of the engine is transmitted to the rotating blade 1003 through a drive shaft (not illustrated) inserted in the manipulation rod 1005. A worker operates the brush cutter 1001, with his or her hands holding a handle 1004 attached to the manipulation rod 1005.

The two-cycle engine employed in the brush cutter 1001 can obtain a strong output with a compact and lightweight configuration, and can work for long periods of time by supply of fuel. However, since the two-cycle engine does not include an intake valve and an exhaust valve in a cylinder, contrary to a four-cycle engine, a technique is widely utilized in which the cylinder is provided with a reed valve to prevent air flowing in a crankcase from flowing backward. In addition, the engine is provided with a governor device that closes an air-fuel mixture passage when an engine rotating speed exceeds a predetermined value, thereby preventing overspeed of the engine. For example, in JP-H07-253033A, an insulator is provided at an outer side thereof with a transfer mechanism for displacing a driving body and a cutoff body, and the cutoff body provided in the air-fuel mixture passage is opened or closed by a motor provided on the exterior, depending upon the engine rotating speed.

### SUMMARY

In the governor device disclosed in JP-H07-253033A, since reliability of the cutoff property of the air-fuel mixture passage is slightly insufficient, there is a possibility that inflow of an air-fuel mixture may be allowed by the unreliable cutoff operation. In addition, a space for providing the insulator with the governor device at an outside thereof is necessary, and the transfer mechanism for displacing the cutoff body is somewhat complicated, which becomes a bottleneck at the time of improving more lifespan or reliability thereof Furthermore, since the cutoff body is displaced by the control, there is a problem of lack of quick response.

The present invention has been made to solve the above-mentioned problems occurring in the related art, and an object of the present invention is to provide an engine including a reed valve capable of reliably cutting off flow of an air-fuel mixture into an air-fuel mixture passage to prevent the overspeed of the engine, and an engine working machine equipped with the same.

Another object of the present invention is to provide an engine including a reed valve, of which a closed state is maintained at a desired timing by an electromagnetic force to suppress discharge of unburned gas, and an engine working machine equipped with the same.

Further another object of the present invention is to provide an engine of which reliability is improved at a low cost by incorporating an electromagnetic closure mechanism for a reed valve into an insulator, without changing a size of the insulator, and an engine working machine equipped with the same.

The following is a description of the gist of the representative elements of the invention disclosed in this application.
(1) An engine comprising:
   a cylinder block with a piston being able to reciprocate therein;
   a carburetor configured to supply an air-fuel mixture into the cylinder block;
   a crankcase formed with a crank chamber;
   a reed valve made of a magnetic material and provided in an air-fuel mixture passage through which the air-fuel mixture passes;
   an electromagnet including an iron core having at least two magnetic pole pieces facing the reed valve, and a coil wound around a portion of the iron core; and
   a control unit configured to control the electromagnet.
(2) The engine according to (1), wherein the two magnetic pole pieces are disposed in one of the air-fuel mixture passage and a portion of the air-fuel mixture passage.
(3) The engine according to (2), wherein
   surfaces of the two magnetic pole pieces which contacts the reed valve are formed in an arc shape, and the surface of one of the magnetic pole pieces is disposed symmetrically to the surface of the other magnetic pole piece with respect to an axis of the air-fuel mixture; and
   the iron core includes a U-shape member which is wound with the coil and connects the two magnetic pole pieces each other.
(4) The engine according to (3) further comprising an insulator including an intake passage provided between the carburetor and the cylinder block to communicate an intake port with the carburetor,
   wherein the U-shaped member and the coil are embedded in the insulator.
(5) The engine according to (3), wherein the two magnetic pole pieces and the coil are disposed in the air-fuel mixture passage.
(6) The engine according to (1), wherein the control unit maintains the reed valve in a closed state by feeding an electric current to the electromagnet at a timing that the reed valve is to be deformed.
(7) The engine according to any one of (1) to (6), wherein if an rotating speed of the engine is higher than a target rotating speed, the control unit feeds an electric current to the electromagnet such that a ratio of the number of times of closing the reed valve to a period in which the air-fuel mixture passage is opened is set to be a predetermined ratio by feeding an electric current to the electromagnet.
(8) An engine working machine comprising the engine of (1) to (7).

According to the aspect (1), since a magnetic closed-loop is formed to transfer a line of magnetic force from the two magnetic pole pieces to the reed valve is formed, the reed valve contacts the magnetic pole pieces at magnetization, thereby realizing a strong attractive force. For this reason, there is no concern about inflow of the air-fuel mixture due to the insufficient cutoff property of a fuel passage, the air-fuel mixture can be reliably cut off By reliably cutting off the air-fuel mixture fed to the cylinder from the carburetor, the engine capable of carrying out engine rotating speed control or effective combustion control can be provided.

According to the aspect (2), since the two magnetic pole pieces or magnetic pole pieces of the electromagnet are disposed in the air-fuel mixture passage or in a portion of the air-fuel mixture passage, heating caused by the coil can be effectively cooled by the intake air.

According to the aspect (3), since surfaces of the two magnetic pole pieces which contact the reed valve are formed in the arc shape, and recess portions of the magnetic pole pieces are disposed symmetrically each other with respect to the axis of the air-fuel mixture, an attractive area formed by a magnetic force can be widely obtained. Therefore, it is possible to reliably hold the reed valve in a close state by the electromagnet.

According to the aspect (4), since the U-shaped iron core and the coil are embedded in the insulator, the engine having high reliability and long lifespan can be realized, without rattling or disconnection of the coil.

According to the aspect (5), since the two magnetic pole pieces and the coil are disposed in the air-fuel mixture passage, the heating caused by the coil can be extremely effectively cooled by the intake air. Further, since the electromagnet is not necessary to be cast in the insulator, a cost for fabricating the insulator can be reduced.

According to the aspect (6), since the control unit maintains the reed valve in the closed state by feeding the electric current to the electromagnet at the timing of opening the reed valve, it is possible to effective lower the rotating speed of the engine without generating unburned gas.

According to the aspect (7), if the rotating speed of the engine is higher than the target rotating speed, the control unit feeds the electric current to the electromagnet such that a ratio of the number of times of closing the reed valve to a period of opening of the air-fuel mixture passage is set to be a predetermined ratio. As a result, it is possible to reliably restrict the engine rotating speed for the two-cycle engine which is hard to be controlled.

According to the aspect (8), since the engine working machine employing the engine set forth in any one of (1) to (7) is realized, the engine working machine with easy rotation control and convenient use can be provided.

The above and other objects, and new features of the present invention will be more apparent from the following description taken in conjunction with the accompanying drawings.

### BRIEF DESCRIPTION OF DRAWINGS

FIG. 1 is a cross-sectional view illustrating the whole configuration of an engine including a reed valve according to the present invention.

FIG. 2 is an enlarged side view illustrating an insulator assembly (portion circled by the dotted line A in FIG. 1) in FIG. 1.

FIG. 3 is a side view illustrating the insulator assembly in FIG. 1 when seen from a cylinder block 8 (seen from the arrow B in FIG. 2).

FIG. 4 is a developed view illustrating a construction of the insulator assembly in FIG. 1.

FIG. 5 is a side view illustrating an insulator 19 in FIG. 3, in which a stopper 23 and a reed valve 21 are detached from the insulator assembly.

FIG. 6 is a cross-sectional view taken along the line C-C in FIG. 5.

FIG. 7 is a bottom view of the insulator 19 in FIG. 5 when seen from the arrow D in FIG. 5.

FIG. 8 is a side view illustrating the insulator assembly carrying an electromagnet 27, in which the stopper 23 and the reed valve 21 are detached from the insulator assembly.

FIG. 9 is a bottom view of the insulator assembly carrying the electromagnet 27 in FIG. 1, when seen from the direction E in FIG. 8.

FIG. 10 is a view illustrating the flow of lines of magnetic force in the insulator assembly in FIG. 1 when an iron core 25 is attracted to a reed valve 21.

FIG. 11 is a side view illustrating the state in which the reed valve 21 of the insulator assembly in FIG. 1 is maximally opened, and thus contacts the stopper 23.

FIG. 12 is a control block diagram illustrating an engine 1 according to an embodiment of the present invention.

FIG. 13 is a timing chart diagram illustrating an operation of an intake opening of the reed valve 21 and a valve driving unit 35 in the engine 1 according to the embodiment of the present invention.

FIG. 14 is another timing chart diagram illustrating the operation of the intake opening of the reed valve 21 and the valve driving unit 35 in the engine 1 according to the embodiment of the present invention.

FIG. 15 is further another timing chart diagram illustrating the operation of the intake opening of the reed valve 21 and the valve driving unit 35 in the engine 1 according to the embodiment of the present invention.

FIG. 16 is a side view of an insulator 119 according to a second embodiment of the present invention.

FIG. 17 is a side view of an insulator assembly according to a third embodiment of the present invention.

FIG. 18 is a side view illustrating the insulator assembly according to the third embodiment of the present invention when seen from an intake port 14 side.

FIG. 19 is a side view illustrating the insulator assembly according to the third embodiment of the present invention, in which the stopper 23 and the reed valve 21 are detached from the insulator assembly.

FIG. 20 is a cross-sectional view of the insulator assembly according to the third embodiment of the present invention.

FIG. 21 is a cross-sectional view of an insulator assembly according to a fourth embodiment of the present invention.

FIG. 22 is a perspective view of a brush cutter which is an example of an engine working machine.

### DESCRIPTION OF EXEMPLARY EMBODIMENTS

### First Embodiment

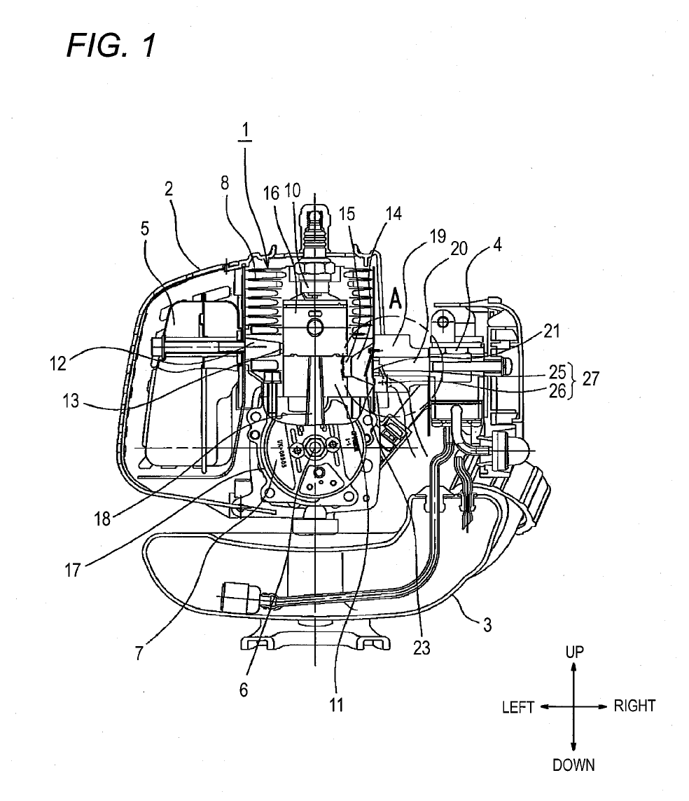

Hereinafter, exemplary embodiments according to the present invention will now be described with reference to the accompanying drawings. Throughout the disclosure, same reference numerals refer to the similar parts throughout the various figures and embodiments of the present invention, and the repeated description thereof will be omitted herein. In addition, the terms ‘up and down direction’ and ‘left and right direction’ herein are used on the basis of the directions shown in FIG. 1.

In FIG. 1, an engine 1 accommodated in an engine cover 2 includes: a carburetor 4 for mixing fuel supplied from a fuel tank 3 with air and supplying the air-fuel mixture to the engine 1; a muffler 5; a magnet rotor 7 fixed to a crank shaft 6, an ignition coil (not illustrated) fixed to a cylinder block 8 of the engine 1; and an ignition plug 10 connected to the ignition coil. A cylinder bore formed in the cylinder block 8 is provided in an inner peripheral wall thereof with an exhaust opening 13, an intake opening 15 connected to an intake port 14, and a scavenging port (not illustrated) connected to a scavenging passage (not illustrated).

A piston 16 is accommodated in the cylinder bore 11 such that the piston is able to reciprocate up and down therein. When the piston 16 moves up and down, the exhaust opening 13, the intake opening 15, and the scavenging opening (not illustrated) are respectively opened and closed by a side wall of the piston 16. FIG. 1 illustrates the state in which the piston 16 is positioned at a top dead center. In this instance, the exhaust opening 13 is fully closed, while the intake opening 15 is fully opened. The piston 16 is connected to a crank shaft 6 via a connecting rod 18, and the crank shaft 6 is rotatably supported by a crankcase 17 attached to a bottom of the cylinder block 8. The cylinder block 8 is connected to the muffler 5 to communicate with the exhaust port 12. The intake port 14 of the cylinder block 8 is connected to the carburetor 4 via an insulator 19.

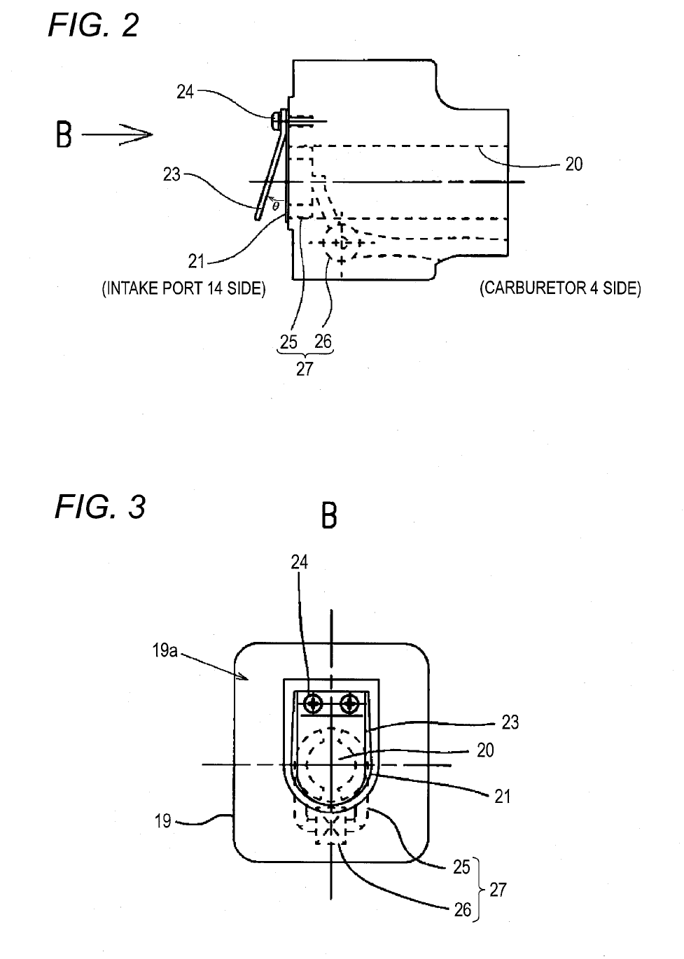

FIG. 2 is an enlarged side view of an insulator assembly (portion circled by the dotted line A in FIG. 1) in FIG. 1. The term ‘insulator assembly’ herein refers to an assembly of components incorporated between the cylinder block 8 and the carburetor 4. The insulator assembly includes an insulator 19, a few components (21, 23 and 24; will be described in detail hereinafter) provided on the insulator 19 at the intake port 14 side, and an electromagnet 27 additionally provided in this embodiment. Since the insulator 19 is interposed between the intake port 14 and the carburetor 4, the insulator formed a portion of the air-fuel mixture passage. The intake passage 20 of a desired length is formed to improve an intake efficiency. The insulator 19 is fabricated by integral molding of polymeric resin such as plastic.

The insulator 19 is provided with a reed valve (intake control valve) 21 at the end portion thereof facing the intake port 14 side. The reed valve 21 is a resiliently deformable plate-shaped magnetic body made of stainless steel or bainite steel. The reed valve 21 has a sufficient area to fully cover the opening portion of the intake passage 20 of the insulator 19, and is supported in a cantilever shape by a screw 24 together with a stopper 23 that is provided on the reed valve 21 at the intake port 14 side. If the piston 16 moves up and thus a pressure difference between an interior of a crank chamber and an interior of the intake passage 20 exceeds a predetermined value (if a negative pressure is generated in the crank chamber), the reed valve 21 is resiliently deformed towards the intake port 14 side, so that the intake passage 20 communicates with the intake port 14. In addition, in the state in which the reed valve 21 is not deformed (state illustrated in FIG. 2), the reed valve 21 covers the entire opening portion of the intake passage 20 at the intake port side, thereby closing the intake passage 20.

An electromagnet 27 is provided on the end portion of the intake passage 20 of the insulator 19 at the position opposed to the reed valve 21. The electromagnet 27 has an iron core 25 contacting the reed valve 21 at a desired area, and a coil 26 wound around a portion of the iron core 25. The electromagnet 27 controls generation/stop of a magnetic force at a desired timing by turning on or off the energization of the coil 26. In particular, the electromagnet 27 can generate a high attractive force by a smaller electric input. The intake passage 20 is provided therein with a magnetic pole piece portion that is a portion of the iron core 25 and comes into contact with the reed valve 21. The remaining portion of the iron core 25 and the coil 26 are embedded (cast) in the insulator 19.

FIG. 3 is a side view illustrating the insulator assembly in FIG. 1 when seen from the cylinder block 8 (seen from the arrow B in FIG. 2). The insulator 19 has a substantially rectangular cross section which is vertical to the flow of the intake air. The circular intake passage 20 is formed near the almost center portion of the insulator when seen like FIG. 3. The reed valve (intake control valve) 21 is provided on the end portion 19a of the insulator 19 facing the intake port 14 side. The reed valve 21 is configured to have a size sufficiently larger than a diameter of the intake passage 20. The reed valve 21 is supported in a cantilever shape on the end portion 19a of the insulator 19 facing the intake port 14 side by two screws 24 together with the stopper 23. Preferably, the shape or size of the reed valve 21 is substantially identical to that of a reed valve which is commercially used in the art. The portion which is a portion of the electromagnet 27 and serves as the magnetic pole piece is provided in the intake passage 20, and the coil 26 is embedded in the insulator 19.

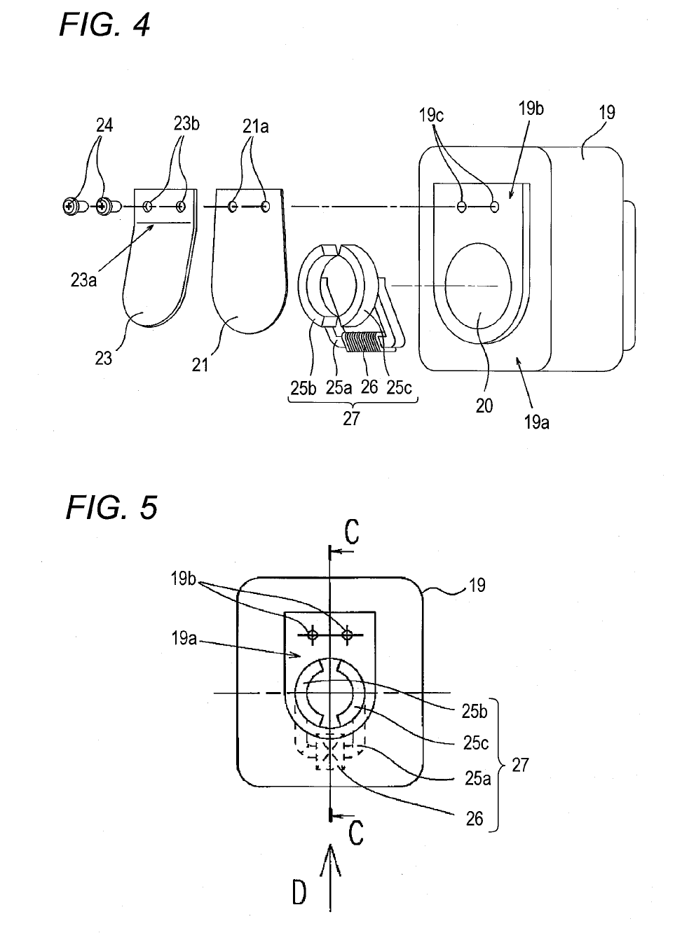

FIG. 4 is a developed view illustrating the construction of the insulator assembly. Although the insulator 19 is formed with the electromagnet 27 by casting, the insulator 19 and the electromagnet 27 are separately illustrated in FIG. 4 to easily understand the shape. In practice, when the insulator 19 is fabricated by integral molding of synthetic resin, most of the electromagnet 27 is cast therein. The end portion 19a of the insulator 19 facing the intake port 14 side is provided with an attachment surface 19b for attaching the reed valve 21. The attachment surface 19b protrudes toward the intake port 14 side in a stepped shape so as to be positioned with respect to the cylinder block. The attachment surface has a size slightly larger than the reed valve 21 depending upon the inner shape of the intake port 14. The attachment surface 19b is provided at an upper portion thereof with two screw holes 19c for fixing the screws 24, and a female threaded portion is formed on the inner surface of the respective screw holes 19c.

The electromagnet 27 is formed by the iron core 25 (25a to 25c) and the coil 26. The iron core 25 is composed of two magnetic pole pieces 25b and 25c and a U-shaped portion 25a for connecting these magnetic pole pieces. The coil 26 is wound around the center portion (bottom portion of U character) of the U-shaped portion 25a, and energization of the coil 26 causes the iron core 25 to generate a magnetic flux in a predetermined direction. As a result, the magnetic pole piece 25b can be magnetized to an N-pole, and the magnetic pole piece 25c can be magnetized to an S-pole. The magnetic pole pieces 25b and 25c are formed in the shape of arch-shaped semi-cylinder. The magnetic pole pieces 25b and 25c facing each other are symmetrically arranged to each other with respect to an axis of the intake passage 20 so that each concave portion faces each other. The magnetic pole pieces 25b and 25c are disposed at a predetermined interval not to contact each other, and are fixed to the U-shaped portion 25b by welding or the like. The magnetic pole pieces 25b and 25c are arranged not to be exposed to the outside when the magnet 27 is cast in the insulator 19. In this embodiment, the magnetic pole pieces 25b and 25c are provided to be positioned in the intake passage 20. In this embodiment, the magnetic pole pieces 25b and 25c are formed to have an outer diameter identical to an inner diameter of the intake passage 20. Meanwhile, although not illustrated in FIG. 4, two lead lines are extended from the coil 26 to supply a DC current.

The reed valve 21 and the stopper 23 are fixed to the attachment surface 19b by the two screws 24. The stopper 23 is a component formed by bending a thin plate, for example, a stainless steel plate, and determines a maximum angle θ (see FIG. 2) when the reed valve 21 is resiliently deformed. Since the stopper 23 has a role of preventing the reed valve 21 from being resilient deformed beyond a predetermined level, it is preferable for the stopper to have sufficient strength not to be deformed by contact of the reed valve 21.

FIG. 5 is a side view illustrating the insulator 19 in FIG. 3 when seen from the intake port 14 side, in which the stopper 23 and the reed valve 21 are detached from the insulator assembly. The insulator 19 according to this embodiment has the same size as that of an insulator of a related art, except for the electromagnet 27 is cast therein. Accordingly, the present invention can be easily achieved by displacing the insulator of the related art by the insulator 19 according to this embodiment. Meanwhile, the figures of the insulator 19 in the disclosure illustrates the screw holes through which the screws penetrate to attach the insulator 19 to the cylinder block 8, but the insulator may be provided with two to four screw holes as necessary.

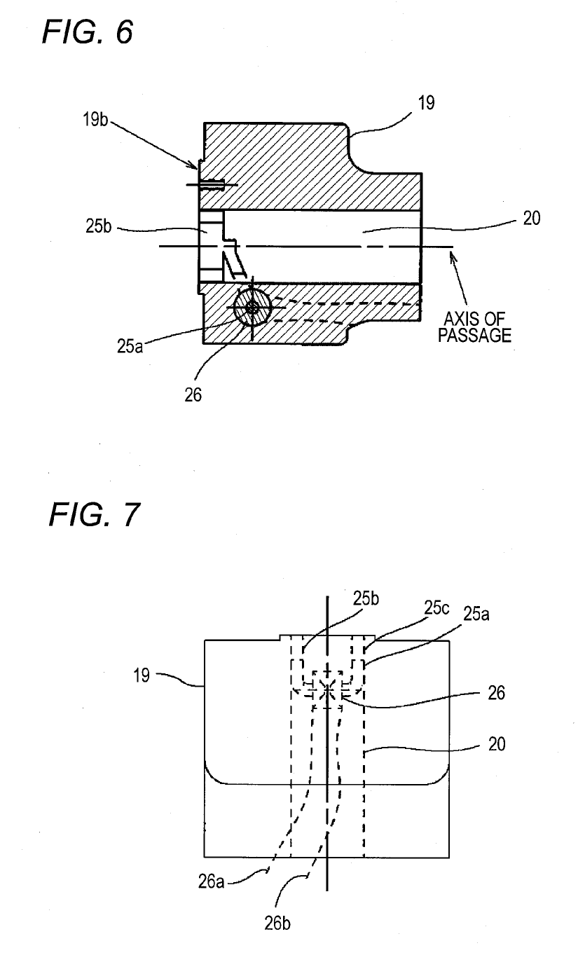

FIG. 6 is a cross-sectional view taken along the line C-C in FIG. 5. The relationship between the inner diameter of the intake passage 20 of the insulator 19 and the size of the magnetic pole pieces 25b or 25c of the iron core 25 would be understood from FIG. 5. In addition, since the end portion of the magnetic pole piece 25b or 25c facing the intake port 14 side is disposed to be flush with the attachment surface 19b of the insulator 19, it would be understood that the magnetic pole pieces 25b and 25c contacts the reed valve 21 when the reed valve 21 is closed. The cross section of the intake passage is reduced by providing the intake passage 20 with the magnetic pole pieces 25b and 25c therein. In this instance, it is preferable to configure the intake passage 20 to have slightly large inner diameter, as compared the insulator of the related art which is not provided with the magnetic pole piece in the intake passage. Most of the U-shaped portion 25a of the iron core 25 fixing the magnetic pole pieces 25b and 25c is cast in the insulator 19. In addition, since all the coil 26 wound around the U-shaped portion 25a is cast in the insulator 19, it is possible to prevent the U-shaped portion from being polluted by oil or the like, or being snapped due to vibration.

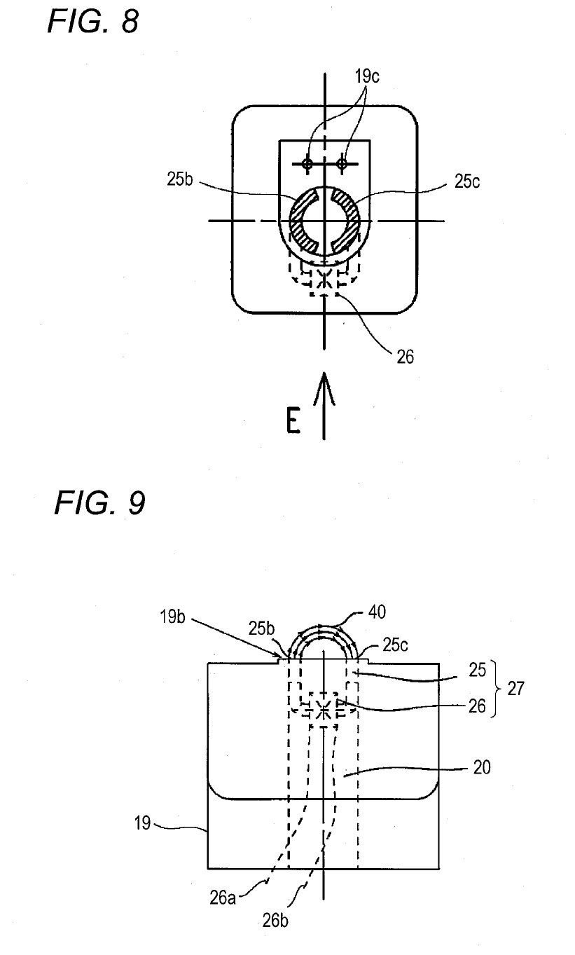

FIG. 7 is a bottom view of the insulator 19 when seen from the arrow D in FIG. 5. As can be seen from FIG. 7, the iron core 25 and the coil 26 are provided on the end portion of the insulator 19 close to the intake port 14. The coil 26 is provided with two power lines 26a and 26b to feed a DC current to the coil 26. If the current is fed to the coil 26 to generate a magnetic field from the magnetic pole pieces 25b and 25c of the iron core 25, the magnetic pole piece 25b is magnetized to an N-pole, and the magnetic pole piece 25c is magnetized to an S-pole. This state is illustrated in FIG. 8, and portions 25b and 25c indicated by oblique hatching in FIG. 6 serve as the attachment surface strongly attracting the reed valve 21 by magnetization. It is reliably maintained by the substantially cylindrical portions (its diameter is identical to the outer diameter of the intake passage) indicated by oblique hatching, in addition to fixing the screws into the two screw holes 19c.

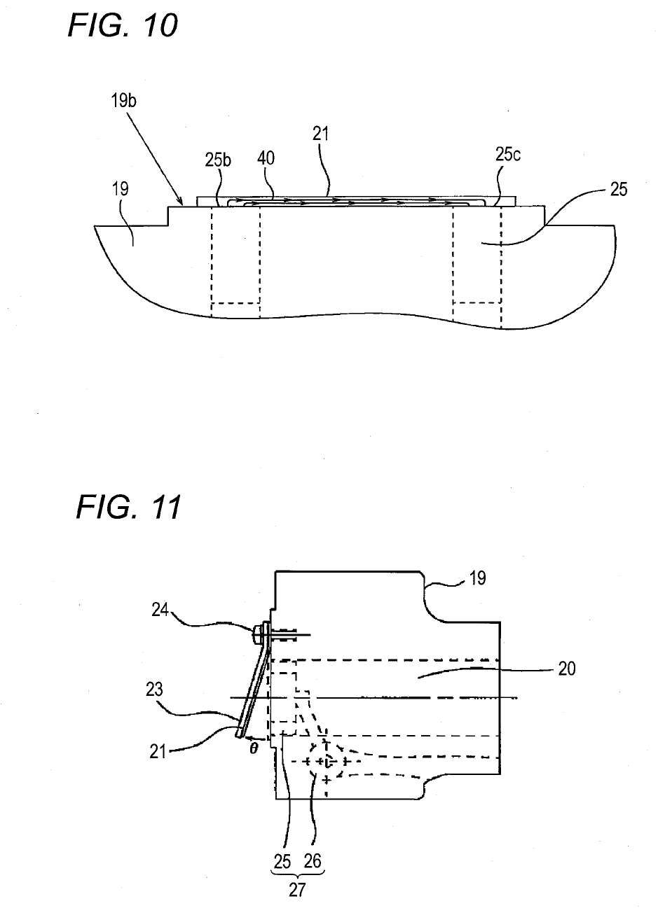

FIG. 9 is a bottom view of the insulator assembly in FIG. 1, with it carrying the electromagnet 27, when seen from the direction E in FIG. 8. In FIG. 9, a line 40 of magnetic force directed from the magnetic pole piece 25b (N-pole) to the magnetic pole piece 25c (S-pole) is shown. As illustrated in FIG. 9, the line 40 of magnetic force directed from the magnetic pole piece 25b (N-pole) to the magnetic pole piece 25c (S-pole) is guided by the reed valve 21 made of a magnetic body, which forms a closed circuit. For this reason, the reed valve 21 is strongly attracted toward the insulator 19 side, thereby reliably maintaining the state in which the intake passage 20 is closed by the reed valve 21. In the case in which a small quantity of the DC current is fed to the electromagnet 27, the attractive force is sufficiently strong. Even though a large negative pressure is applied to the intake port 14 side, the reed valve 21 is not opened. FIG. 10 is a view illustrating the flow of lines of magnetic force in the insulator assembly in FIG. 1 when the iron core 25 is attracted to a reed valve 21. If the reed valve 21 is attracted to the insulator 19 side, the line 40 of magnetic force passes through the reed valve 21 made of the magnetic body, and is directed from the magnetic pole piece 25b (N-pole) to the magnetic pole piece 25c (S-pole). The free end side of the reed valve 21 is not detached from the attachment surface 19b of the insulator 19 by the negative pressure of the crank chamber unless the supply of the current to the coil 26 of the electromagnet 27 is stopped.

FIG. 11 is a side view illustrating the state in which the reed valve 21 of the insulator assembly is maximally opened, and thus contacts the stopper 23. In general, when the piston 16 moves up and thus the pressure difference between the interior of the crank chamber and the interior of the intake passage 20 exceeds a predetermined value (if the negative pressure is generated in the crank chamber), the reed valve 21 is resiliently deformed toward the intake port 14 side, so that the intake passage 20 is opened. In this instance, the movable angle of the reed valve 21 is θ. In addition, in the state in which the reed valve 21 is not deformed, the reed valve 21 covers the end portion of the intake passage 20 facing the intake port side, and closes the intake passage 20, thereby preventing the fuel from returning to the intake passage 20 when the crankcase 17 is compressed. In this embodiment, as illustrated in FIG. 9, since the reed valve 21 contacts the magnetic pole pieces 25b and 25c in the state in which the reed valve is closed, by feeding the current to the coil 26, the line 40 of magnetic force illustrated in FIG. 10 passes through the reed valve 21 to form a closed loop, and the reed valve 21 can be forcibly held. Even if the pressure difference between the interior of the crank chamber and the intake passage 20 is increased, it is possible to close the intake passage 20. As a result, in the case in which it is not necessary to feed the air-fuel mixture to the cylinder bore 11 side, it is possible to reliably prevent the inflow of the air-fuel mixture only by sending an electrical command from a computation unit 36 to a valve driving unit 35.

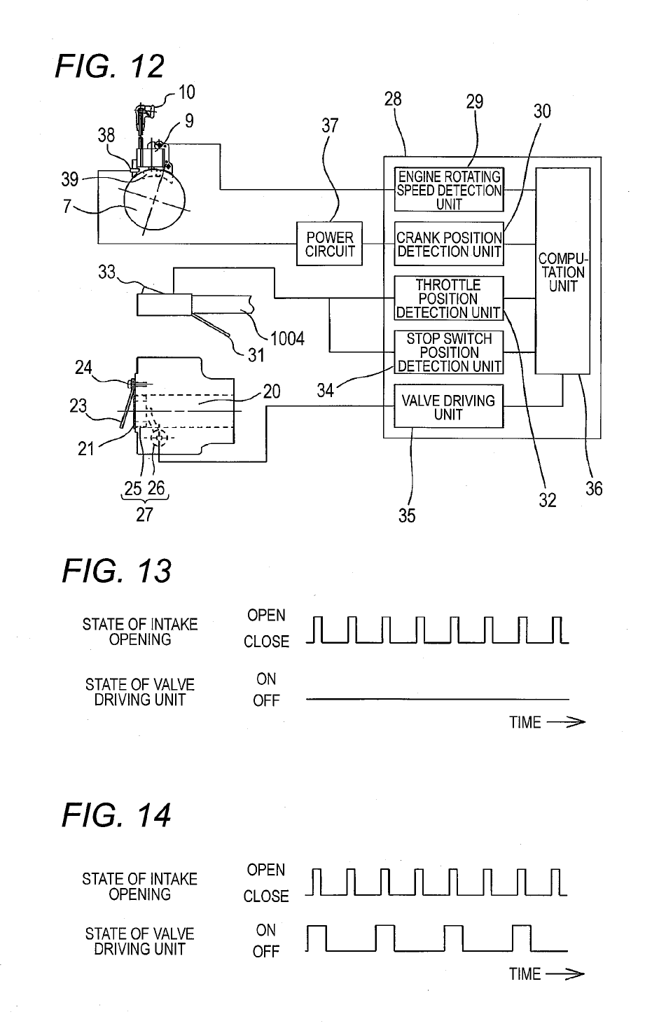

FIG. 12 is a control block diagram illustrating the engine 1 according to the embodiment of the present invention. A controller unit (control means) 28 employed by the engine 1 includes a engine rotating speed detection unit (driving state detecting means) 29 for detecting an rotating speed of the engine 1, a crank position detection unit (driving state detecting means) 30 for detecting a position (crank angle or piston position) of the crank shaft 6 of the engine 1, a throttle position detection unit (driving state detecting means, idling state detecting means, and throttle operating state detecting means) 32 for detecting a position of a throttle lever 31 provided on the handle 1004, a stop switch position detection unit (driving state detecting means) 34 for detecting a position of a stop switch 33, provided on the handle 1004, for stopping the engine 1, the valve driving unit 35 for energizing the coil 26, and the computation unit 36.

The engine rotating speed detection unit 29 detects the rotating speed of the engine 1 by detecting a signal from the ignition coil, and outputs an engine rotating speed signal to the computation unit 36. The crank position detection unit 30 is connected to a power circuit 37, and detects a predetermined position of the crank shaft 6, for example, a top dead center or a position thereof positioned at a predetermined angle before the top dead center, using a voltage pulse generated when a magnet 39 of the magnet rotor 7 passes a charging coil 38 for supplying an electric power to the power circuit 37. When the crank shaft 6 passes a predetermined position, the crank position detection unit 30 outputs a crank position signal indicative of the predetermined position of the crank shaft 6 to the computation unit 36. The crank position detection unit 30 may detect the position of the crank shaft 6 using a voltage pulse generated from the ignition coil, instead of using the charging coil 38. In addition, the throttle position detection unit 32 detects whether the throttle lever 31 is manipulated or not, and outputs the throttle position signal to the computation unit 36. The stop switch position detection unit 34 detects whether the stop switch 33 is operated (engine is stopped) or not, and outputs the stop switch signal to the computation unit 36. The computation unit 36 is input with the signals output from the engine rotating speed detection unit 29, the crank position detection unit 30, the throttle position detection unit 32, and the stop switch position detection unit 34, and outputs a signal of energizing the coil 26 to operate the electromagnet 27 to the valve driving unit 35.

In the case in which the throttle position detection unit 32 detects the state in which the throttle lever 31 is not manipulated (the throttle is closed), and the engine rotating speed detection unit 29 detects that the rotating speed of the engine 1 is below an idling rotating speed, for example, 3000 rpm or less, as illustrated in FIG. 13, the controller unit 28 does not operate the valve driving unit 35. That is, in this instance, where the intake opening 15 is opened or closed (top on the figure) in association with the reciprocating movement of the piston, the valve driving unit 35 is not operated, so that the state, in which the reed valve 21 closes the intake passage 20, is not maintained.

From the above state, if the rotating speed of the engine 1 is increased and the engine rotating speed detection unit 29 detects a first engine rotating speed higher than the idling rotating speed, for example, a speed of 3500 rpm or more, that is, if the throttle position detection unit 32 detects the state in which the throttle lever 31 is not manipulated (throttle is closed) and the engine rotating speed detection unit 29 detects the engine rotating speed exceeding the first engine rotating speed, the controller unit 28 drives the valve driving unit 35, as illustrated in FIG. 14, at the timing when the intake opening 15 is opened, based on the crank position signal output from the crank position detection unit 30 and the engine rotating speed signal output from the engine rotating speed detection unit 29, so that a ratio of the number of times of closing the intake passage 20 during opening of the intake opening 15 to the number of times of opening the intake opening is set to be a predetermined value, that is, ½. In this instance, where the ratio of the number of times of opening and closing the intake opening 15 in association with the reciprocating movement of the piston is set to be ½, the state, in which the reed valve 21 closes the intake passage 20, is maintained by the operation of the valve driving unit 35 while the intake opening 15 is opened. Meanwhile, by operating the valve driving unit 35 faster than the timing of opening the intake opening 15, it is preferable to energize the electromagnet 27 in the state in which the reed valve 21 closes the intake passage 20 (the state in which the reed valve 21 is not deformed) and thus to attract the reed valve 21 to the electromagnet 27. Meanwhile, if the opening angle θ of the reed valve 21 is small, it is possible to attract the reed valve 21 by the magnetic flux generated from the magnetic pole pieces 25b and 25c.

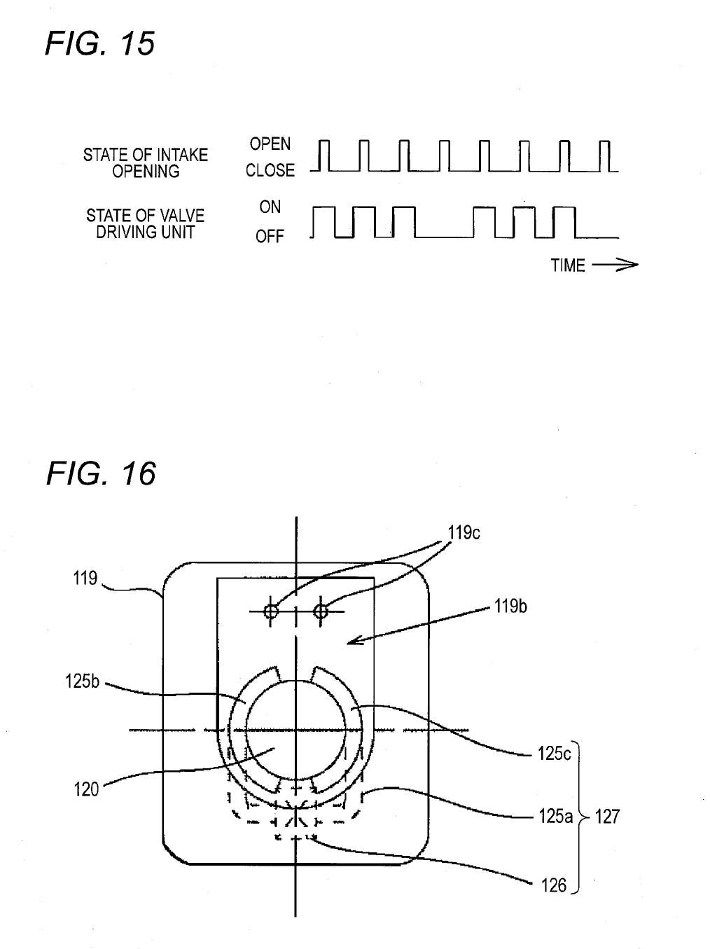

If the rotating speed of the engine 1 is further increased and the engine rotating speed detection unit 29 detects a second engine rotating speed higher than the first engine rotating speed, for example, 3600 rpm or more, that is, if the throttle position detection unit 32 detects the state in which the throttle lever 31 is not manipulated (throttle is closed) and the engine rotating speed detection unit 29 detects the engine rotating speed exceeding the second engine rotating speed, the controller unit 28 drives the valve driving unit 35, as illustrated in FIG. 15, at the timing when the intake opening 15 is opened, based on the crank position signal output from the crank position detection unit 30 and the engine rotating speed signal output from the engine rotating speed detection unit 29, so that a ratio of the number of times of closing the intake passage 20 during opening of the intake opening to the number of times of opening the intake opening 15 is set to be another predetermined value, that is, ¾ (to change the predetermined value from ½ to ¾). In this instance, where the ratio of the number of times of opening and closing the intake opening 15 in association with the reciprocating movement of the piston is set to be ¾, the state, in which the reed valve 21 closes the intake passage 20, is maintained by the operation of the valve driving unit 35 while the intake opening 15 is opened. Meanwhile, in this instance, by operating the valve driving unit 35 faster than the timing of opening the intake opening 15, it is preferable to energize the electromagnet 27 in the state in which the reed valve 21 closes the intake passage 20 (the state in which the reed valve 21 is not deformed) and thus to attract the reed valve 21 to the electromagnet 27.

In the case in which the throttle position detection unit 32 detects the state in which the throttle lever 31 is not manipulated, and the engine rotating speed detection unit 29 detects that the rotating speed of the engine 1 is below a third engine rotating speed, for example, 8000 rpm or less, as illustrated in FIG. 13, the controller unit 28 does not operate the valve driving unit 35. That is, in this instance, where the intake opening 15 is opened or closed (top on the figure) in association with the reciprocating movement of the piston, the valve driving unit 35 is not operated, so that the state, in which the reed valve 21 closes the intake passage 20, is not maintained. From the above state, if the rotating speed of the engine 1 is increased and the engine rotating speed detection unit 29 detects a fourth engine rotating speed higher than the third engine rotating speed, for example, a speed of 9000 rpm or more, that is, if the throttle position detection unit 32 detects the state in which the throttle lever 31 is not manipulated (throttle is closed) and the engine rotating speed detection unit 29 detects the engine rotating speed exceeding the fourth engine rotating speed, the controller unit 28 drives the valve driving unit 35, as illustrated in FIG. 14, at the timing when the intake opening 15 is opened, based on the crank position signal output from the crank position detection unit 30 and the engine rotating speed signal output from the engine rotating speed detection unit 29, so that a ratio of the number of times of closing the intake passage 20 during opening of the intake opening to the number of times of opening the intake opening 15 is set to be a predetermined value, that is, ½. In this instance, where the ratio of the number of times of opening and closing the intake opening 15 in association with the reciprocating movement of the piston is set to be ½, the state, in which the reed valve 21 closes the intake passage 20, is maintained by the operation of the valve driving unit 35 while the intake opening 15 is opened. Meanwhile, by operating the valve driving unit 35 faster than the timing of opening the intake opening 15, it is preferable to energize the electromagnet 27 in the state in which the reed valve 21 closes the intake passage 20 (the state in which the reed valve 21 is not deformed) and thus to attract the reed valve 21 to the electromagnet 27.

If the rotating speed of the engine 1 is further increased and the engine rotating speed detection unit 29 detects a fifth engine rotating speed higher than the fourth engine rotating speed, for example, 9100 rpm or more, that is, if the throttle position detection unit 32 detects the state in which the throttle lever 31 is not manipulated (throttle is closed) and the engine rotating speed detection unit 29 detects the engine rotating speed exceeding the fifth engine rotating speed, the controller unit 28 drives the valve driving unit 35, as illustrated in FIG. 15, at the timing when the intake opening 15 is opened, based on the crank position signal output from the crank position detection unit 30 and the engine rotating speed signal output from the engine rotating speed detection unit 29, so that a ratio of the number of times of closing the intake passage 20 during opening of the intake opening 15 to the number of times of opening the intake opening 15 is set to be another predetermined value, that is, ¾ (to change the predetermined value from ½ to ¾). In this instance, where the ratio of the number of times of opening and closing the intake opening 15 in association with the reciprocating movement of the piston is set to be ¾, the state, in which the reed valve 21 closes the intake passage 20, is maintained by the operation of the valve driving unit 35 while the intake opening 15 is opened. Meanwhile, in this instance, by operating the valve driving unit 35 faster than the timing of opening the intake opening 15, it is preferable to energize the electromagnet 27 in the state in which the reed valve 21 closes the intake passage 20 (the state in which the reed valve 21 is not deformed) and thus to attract the reed valve 21 to the electromagnet 27.

If the stop switch position detection unit 34 detects the operating state of the stop switch 33 (state of stopping the engine 1) and the engine rotating speed detection unit 29 detects the rotating state of the engine 1, the controller unit 28 operates the valve driving unit 35 such that the intake passage 20 is always closed at the timing of opening the intake opening 15 at all number of times of opening and closing the intake opening 15 in association with the reciprocating movement of the piston. Meanwhile, if the rotation of the engine 1 is not detected and the stop switch position detection unit 34 merely detects the operation of the stop switch 33, the controller unit may be configured to operate the valve driving unit 35, for example, for a predetermined period of time, at the timing of opening of the intake opening 15, so that the intake passage 20 is always closed while the intake opening 15 is opened.

With the engine 1 including the above configuration, if the rotating speed of the engine 1 is increased at idling, for example, exceeds 3500 rpm, the controller unit 28 maintains the state, in which the reed valve 21 closes the intake valve 20 during opening of the intake opening 15, by the operation of the valve driving unit 35 at ½ of the number of times of opening and closing the intake opening 15. As a result, the supply of the air-fuel mixture to the crank chamber is restricted to suppress the increase in rotating speed of the engine 1, and it is possible to control the idling rotating speed to maintain 3000 rpm. If the rotating speed of the engine 1 exceeds 3500 rpm, the controller unit 28 maintains the state in which the reed valve 21 closes the intake valve 20 during opening of the intake opening 15 by the operation of the valve driving unit 35 at ¾ of the number of times of opening and closing the intake opening 15. As a result, the supply of the air-fuel mixture to the crank chamber is restricted to further suppress the increase in rotating speed of the engine 1, and it is possible to effectively control the idling rotating speed to maintain 3000 rpm. Therefore, it is possible to reliably maintain the idling state of the engine 1. Immediately after starting, it is also possible to suppress excessive increase in idling rotating speed, which operates a centrifugal clutch, due to the operation of a starting auxiliary mechanism, such as an idle-up device.

In the case in which the rotating speed of the engine 1 is increased at idling, since the supply of the air-fuel mixture to the crank chamber is gradually restricted by the controller unit 28 depending upon the engine rotating speed, the driving state of the engine 1 is not abruptly changed. It is also possible to improve its operability by suppressing a worker's feeling that something is wrong. In addition, since the supply of the air-fuel mixture is suppressed when the idling rotating speed is increased, discharge of unburned gas can be suppressed, thereby realizing low-emission characteristics and reducing fuel consumption.

If the rotating speed of the engine 1 is excessively increased, for example, exceeds a speed of 9000 rpm, during manipulation of the throttle lever 31, the control unit 28 maintains the state in which the reed valve 21 closes the intake passage 20 during opening of the intake opening 15 by operation of the valve driving unit 15 at ½ of the number of times of opening and closing the intake opening 15. As a result, the supply of the air-fuel mixture to the crank chamber is restricted to suppress the excessive increase in rotating speed of the engine 1, and it is possible to control the rotating speed of the engine 1 below 9000 rpm.

If the rotating speed of the engine 1 exceeds a speed of 9500 rpm, the control unit 28 maintains the state in which the reed valve 21 closes the intake passage 20 during opening of the intake opening 15 by operation of the valve driving unit 15 at ¾ of the number of times of opening and closing the intake opening 15. As a result, the supply of the air-fuel mixture to the crank chamber is further restricted to suppress the excessive increase in rotating speed of the engine 1, and it is possible to effectively control the rotating speed of the engine 1 to maintain a practical upper limit of 9000 rpm. Therefore, it is possible to reliably suppress the excessive rotation of the engine 1.

Meanwhile, the reed valve 21 is not maintained in the state in which it always closes the intake passage 20 during opening of the intake opening 15. For at least a fraction, for example, ¼, of the number of times of opening and closing the intake opening 15, the reed valve 21 is opened to supply the air-fuel mixture to the crank chamber. Accordingly, it is possible to lubricate the interior of the crank chamber by supplying the air-fuel mixture containing lubricant into the crank chamber, thereby suppressing burning of the engine 1 or the like. Further, although the supply of the air-fuel mixture is suppressed at rotation of the engine, since ignition is carried out by the ignition plug 10 for every time, discharge of the unburned gas can be suppressed, thereby realizing low-emission characteristics and reducing fuel consumption.

In the case in which the engine is rotated in spite of that the stop switch 33 operates, at all the number of times of opening and closing the intake opening 15 in association with the reciprocating movement of the piston, the intake passage 20 is always closed by the reed valve 21 during opening of the intake opening 15 at the timing of opening the intake opening 15. Accordingly, discharge of harmful exhaust gas components can be suppressed by stopping the supply of extra air-fuel mixture to the engine 1, thereby reducing fuel consumption and effectively preventing run-on or after-fire.

As mentioned above, since the reed valve 21 can be closed at a desired timing by the electromagnet 27, it is possible to effectively prevent unwanted increase in rotating speed of the engine 1, or run-on or after-fire of the engine 1. In addition, it is not necessary to provide a driving mechanism on the outside of the insulator 19, and a large space for installing a device around the insulator 19 or the engine 1 is not required. Since the engine is easy to assemble, a cost for a product can be suppressed. Further, in the case in which a positive pressure is generated in the crank chamber, the reed valve 21 closes the intake passage 20. When the reed valve 21 closes the intake valve 20, the electromagnet 27 is energized, and thus it is not necessary to attract the reed valve 21 that is spaced apart from the electromagnet 27. Since it is suitable to merely generate a force to maintain the close state in which a gap between the reed valve 21 and the magnetic pole pieces 25b and 25c is zero, fuel consumption can be further suppressed. Furthermore, it is possible to downsize the electromagnet 27. Also, since the engine 1 is a two-cycle engine, the opening and closing timing can be controlled by the simple configuration, without using an intake/exhaust valve or the like.

### Second Embodiment

FIG. 16 is a side view illustrating an insulator 119 according to a second embodiment of the present invention. In the first embodiment, the magnetic pole pieces 25b and 25c are positioned in the intake passage 20, as illustrated in FIG. 5. In the second embodiment, however, magnetic pole pieces 125b and 125c are cast in the insulator 119, as illustrated in FIG. 16, but its inner peripheral wall is configured to be a portion of an inner wall surface of the intake passage 120. The magnetic pole pieces 125b and 125c are provided at a front portion of a U-shaped portion 125a, and an appearance of an electromagnet or an arrangement of a coil 126 is substantially identical to those of the electromagnet 27 illustrated in FIG. 4, except for the U-shaped portion 125a that is wholly cast in the insulator 119.

In this way, the arc-shaped magnetic pole pieces 125b and 125c for covering a portion of an outside of the intake passage 120 of the insulator 119 form a portion of the inner wall of the intake passage 120. Thus, heat generated when an electric current is fed to the coil 126 is transferred to the magnetic pole pieces 125b and 125c via the U-shaped portion 125a, thereby effectively radiating the heat from the magnetic pole pieces 125b and 125c. Meanwhile, the supply of the electric current to the coil 126 is carried out when the engine 1 is driven. Since intake air sufficiently flows along the intake passage 120, an effect of sufficiently radiating the heat can be expected from a portion of the magnetic pole pieces 125b and 125c.

As described above, in the second embodiment, since almost all portion configuring the electromagnet 127 is cast in the insulator 119, the present invention can be realized without exerting an adverse effect on the flow of the intake air flowing in the intake port 14 through the intake passage 120. Further, since the intake passage 120 is formed to have the completely same size as that of the insulator, there is no possibility of deterioration in an intake efficiency. Meanwhile, as well as the first embodiment, if the controller unit 28 is provided with the valve driving unit 35, this embodiment can be easily realized only by replacing an insulator of an existing engine by the insulator 119.

### Third Embodiment

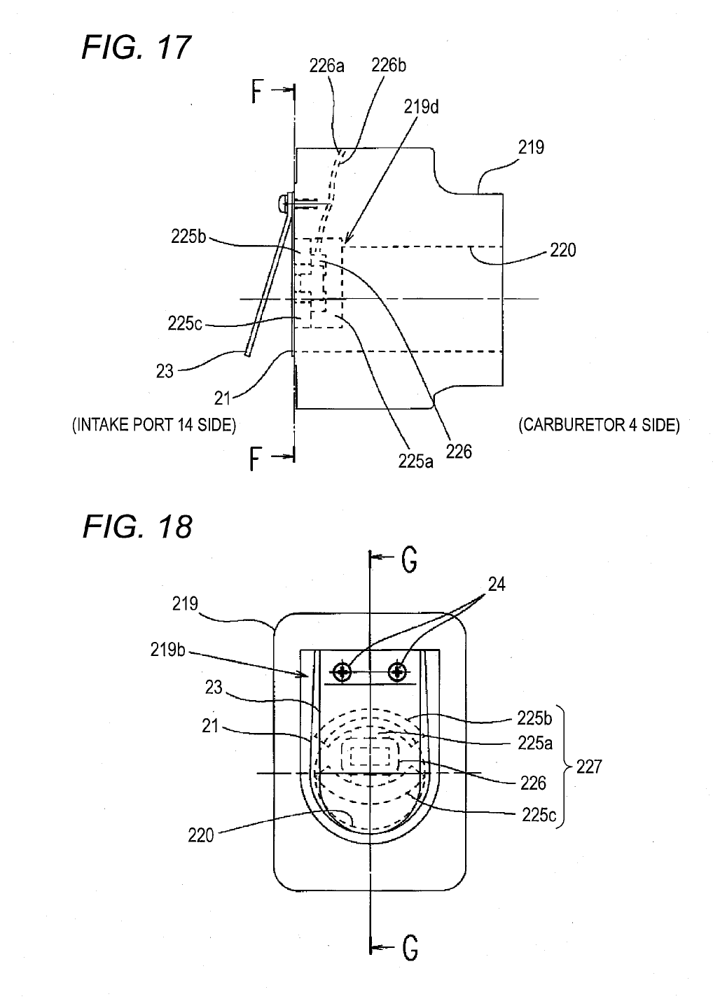

Next, the third embodiment of the present invention will be described with reference to FIGS. 17 to 20. In the third embodiment, an electromagnet is not cast in an insulator 219, but an electromagnet 227 (225a to 225c, 226) is adhesively attached to the insulator 219 after the insulator is molded. For this reason, the insulator 219 is provided with a recess portion 219d of a stepped shape near an exit thereof facing the intake port 14 side, and the electromagnet 227 is adhesively fixed to the recess portion 219d. Since the electromagnet 227 is axially held by the stepped portion of the recess portion 219d of the insulator 219 and the reed valve 21 provided at the intake port 14 side, the electromagnet is reliably maintained without being released from the insulator 219. A method of fixing the electromagnet 227 to the insulator 219 is not limited to the adhesion, but may be carried out by screw fastening or other known means. Two power lines 226a and 226b extended from the coil 226 of the electromagnet 227 may be extended through a penetration hole formed in the insulator 219.

FIG. 18 is a side view illustrating the insulator assembly when seen from the intake port 14 side. The insulator 219 has a substantially rectangular cross section which is vertical to the flow of the intake air, and is provided with a circular intake passage 220 at a substantially center portion thereof The reed valve 21 is provided to a working surface 219b of a stepped shape formed in the insulator 219. The reed valve 21 may utilize the same member as that in the first embodiment, and is formed to have a diameter sufficiently larger than that of the intake passage 220. The reed valve 21 is fixed to the insulator 219 by two screws 24, as well as a stopper 23.

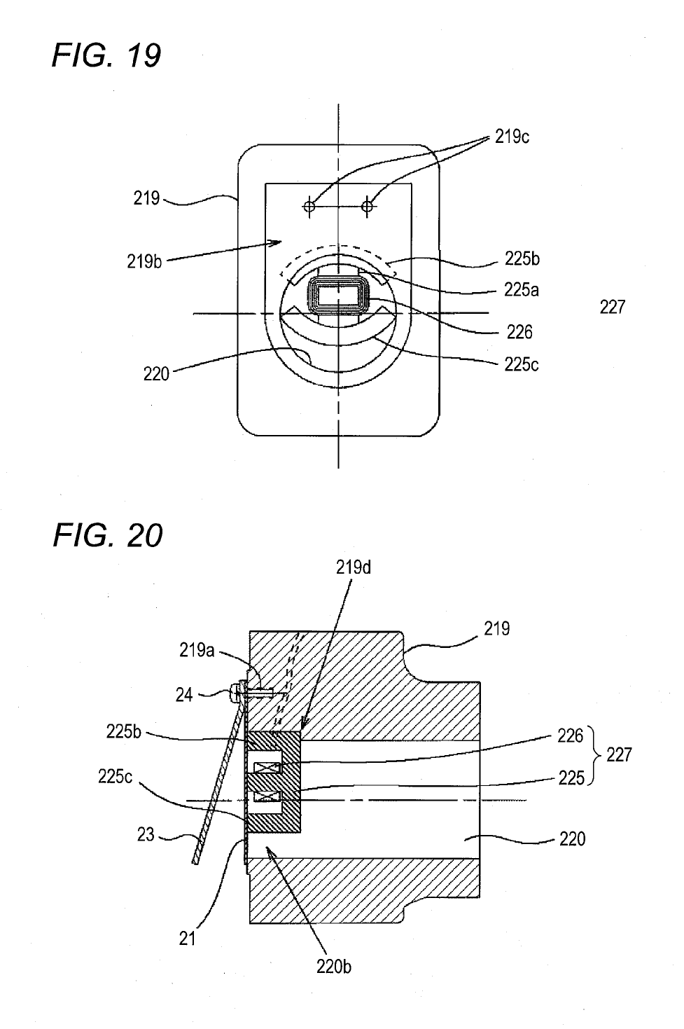

The basic configuration of the electromagnet 227 is substantially identical to that illustrated in the first and second embodiments, and the configuration in which the coil 226 is attached to the iron core 225 (225a to 225c) is identical to that, except for a shape of the iron core 225 of the electromagnet 227 and a position of the electromagnet 227 to be attached to the insulator 219. FIG. 19 is a view illustrating the state in which the stopper 23 and the reed valve 21 are detached from the insulator assembly illustrated in FIG. 18 by releasing the two screws 24. The electromagnet 227 is disposed so that the two magnetic pole pieces 225b and 225c, the E-shaped portion 225a for connecting the magnetic pole pieces, and the coil 226 wound around a protrusion formed at a center portion of the E-shaped portion 225a are exposed in the intake passage 220.

FIG. 20 is a cross-sectional view taken along the line G-G in FIG. 18. The shape of the iron core 225 would be apparent from the figure. The iron core 225 has a substantially E-shaped cross section so that a magnetic gap is formed on the reed valve 21 side, when seen from a cross section of FIG. 18. The coil 226 is disposed around the protrusion formed on the center portion of the iron core. By supplying an electric current to the coil 226 in a predetermined direction, the arc-shaped magnetic pole piece 225b is magnetized to the N-pole, and the arc-shaped magnetic pole piece 225c that is bent in a direction opposite to the magnetic pole piece 225c is magnetized to the S-pole. An outer circular race formed by the magnetic pole piece 225b and the magnetic pole piece 225c is formed to have an outer diameter smaller than an inner diameter of the intake passage 220, thereby obtaining a predetermined space 220b under the magnetic pole piece 225c.

As describe above, in the third embodiment, the portions of the iron core 225 serving as the magnetic pole pieces are provided in the intake passage 220, and have an arc-shape opposite to each other. Since one serves as an N-pole and the other serves as an S-pole, a strong magnetic field can be generated only by supplying an electric current to the coil 226, thereby strongly attracting the reed valve 21 made of metal.

### Fourth Embodiment

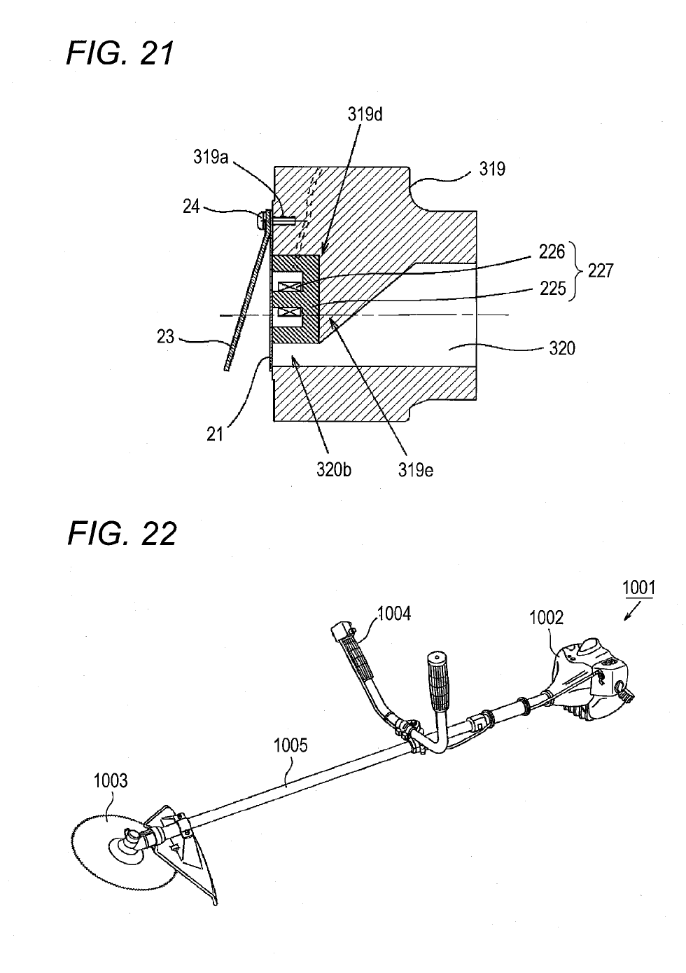

Next, the fourth embodiment of the present invention will be described with reference to FIG. 21. FIG. 21 is a cross-sectional view of an insulator assembly. The fourth embodiment utilizes the same electromagnet 227 as that of the third embodiment. However, the shape of an insulator 319 is partially changed so that an inner diameter of an intake passage 320 is gradually reduced from an inflow side (carburetor 4 side), like a space 320a, to form a small space 320b below the electromagnet 227. By configuring an inclined portion 319e near a center portion of the intake passage of the insulator 319, all portion of the electromagnet 227 at a windward side (at which the carburetor 4 is displaced) is covered by the inclined portion 319e of the insulator 319, and the coil 226 wound around the iron core 225 is embedded in the insulator 319. As a result, the reed valve 21 is strongly attracted to the center side of the intake passage 320, while inflow resistance caused by the electromagnet 227 is suppressed. Further, since the coil portion of the electromagnet 227 is prevented to be directly exposed to the air-fuel mixture containing oil and gasoline, it is possible to effectively prevent alien substances or dust from being stacked on the portion of the electromagnet 227. In addition, by equipping a brush cutter with the above-described engine 1 as a driving source, an engine working machine including a compact and lightweight configuration can be provided, of which a fuel efficiency is high since discharge of unburned gas is suppressed.

As described above, the prevent invention has been described based on the embodiments, but is not limited thereto. Various modifications can be made without departing from the spirit or scope of the invention. For example, the electromagnet 27 and the reed valve 21 are installed in the intake passage 20 in the present invention, but may be installed in a scavenging passage in the case of the two-cycle engine. In this way, it is possible to directly control the flow of the air-fuel mixture from the crankcase 17 to a combustion chamber in a scavenging process. Meanwhile, it is desirable to provide the scavenging passage to a joint portion between the crankcase and the cylinder block. In this instance, by operating the valve driving unit 35 faster than the timing of opening a scavenging opening, the electromagnet is preferably energized to attract the reed valve 21 to the electromagnet 27 while the reed valve 21 closes the scavenging passage (in the state in which the reed valve is not deformed). Further, the present invention is applied to the two-cycle engine in the embodiments, but may be applied to a four-cycle engine. In addition, the above-described engine 1 may be widely mounted to an engine working machine, such as a chain saw, a blower, a hedge trimmer, as well as the brush cutter.

1. An engine comprising:
a cylinder block with a piston being able to reciprocate therein;
a carburetor configured to supply an air-fuel mixture into the cylinder block;
a crankcase formed with a crank chamber;
a reed valve made of a magnetic material and provided in an air-fuel mixture passage through which the air-fuel mixture passes;
an electromagnet including an iron core having at least two magnetic pole pieces facing the reed valve, and a coil wound around a portion of the iron core; and
a control unit configured to control the electromagnet.

2. The engine according to claim 1, wherein the two magnetic pole pieces are disposed in one of the air-fuel mixture passage and a portion of the air-fuel mixture passage.

3. The engine according to claim 2, wherein
surfaces of the two magnetic pole pieces which contacts the reed valve are formed in an arc shape, and the surface of one of the magnetic pole pieces is disposed symmetrically to the surface of the other magnetic pole piece with respect to an axis of the air-fuel mixture; and
the iron core includes a U-shape member which is wound with the coil and connects the two magnetic pole pieces each other.

4. The engine according to claim 3 further comprising an insulator including an intake passage provided between the carburetor and the cylinder block to communicate an intake port with the carburetor,
wherein the U-shaped member and the coil are embedded in the insulator.

5. The engine according to claim 3, wherein the two magnetic pole pieces and the coil are disposed in the air-fuel mixture passage.

6. The engine according to claim 1, wherein the control unit maintains the reed valve in a closed state by feeding an electric current to the electromagnet at a timing that the reed valve is to be deformed.

7. The engine according to claim 1, wherein if a rotating speed of the engine is higher than a target rotating speed, the control unit feeds an electric current to the electromagnet such that a ratio of the number of times of closing the reed valve to a period in which the air-fuel mixture passage is opened is set to be a predetermined ratio by feeding an electric current to the electromagnet.

8. An engine working machine comprising the engine according to claim 1.

9. The engine according to claim 2, wherein if a rotating speed of the engine is higher than a target rotating speed, the control unit feeds an electric current to the electromagnet such that a ratio of the number of times of closing the reed valve to a period in which the air-fuel mixture passage is opened is set to be a predetermined ratio by feeding an electric current to the electromagnet.

10. The engine according to claim 3, wherein if a rotating speed of the engine is higher than a target rotating speed, the control unit feeds an electric current to the electromagnet such that a ratio of the number of times of closing the reed valve to a period in which the air-fuel mixture passage is opened is set to be a predetermined ratio by feeding an electric current to the electromagnet.

11. The engine according to claim 4, wherein if a rotating speed of the engine is higher than a target rotating speed, the control unit feeds an electric current to the electromagnet such that a ratio of the number of times of closing the reed valve to a period in which the air-fuel mixture passage is opened is set to be a predetermined ratio by feeding an electric current to the electromagnet.

12. The engine according to claim 5, wherein if a rotating speed of the engine is higher than a target rotating speed, the control unit feeds an electric current to the electromagnet such that a ratio of the number of times of closing the reed valve to a period in which the air-fuel mixture passage is opened is set to be a predetermined ratio by feeding an electric current to the electromagnet.

13. The engine according to claim 6, wherein if a rotating speed of the engine is higher than a target rotating speed, the control unit feeds an electric current to the electromagnet such that a ratio of the number of times of closing the reed valve to a period in which the air-fuel mixture passage is opened is set to be a predetermined ratio by feeding an electric current to the electromagnet.

14. An engine working machine comprising the engine according to claim 2.

15. An engine working machine comprising the engine according to claim 3.

16. An engine working machine comprising the engine according to claim 4.

17. An engine working machine comprising the engine according to claim 5.

18. An engine working machine comprising the engine according to claim 6.

19. An engine working machine comprising the engine according to claim 7.
